(19) United States
(12) Patent Application Publication
(10) Pub. No.: US 2008/0082615 A1
(43) Pub. Date: Apr. 3, 2008

(54) ELECTRONIC MAIL SERVER APPARATUS, CLIENT APPARATUS, INCOMING MAIL NOTIFICATION METHOD AND INCOMING MAIL NOTIFICATION PROGRAM

(76) Inventor: Etsuo Shinohara, Sagamihara (JP)

Correspondence Address: STAAS & HALSEY LLP, SUITE 700, 1201 NEW YORK AVENUE, N.W., WASHINGTON, DC, 20005, US

(21) Appl. No.: 11/862,662

(22) Filed: Sep. 27, 2007

Related U.S. Application Data
(63) Continuation of application No. PCT/JP2005/005889, filed on Mar. 29, 2005.

(51) Int. Cl. G06F 15/16

(52) U.S. Cl. 709/206

(57) ABSTRACT

An electronic mail server apparatus used for sending and receiving electronic mail reduces a load thereof. The electronic mail server apparatus includes a registration unit (a delivery destination information registration unit) that registers instruction information notified from a delivery destination apparatus (client PCs) of the electronic mail, and a notification unit (a communication unit) that notifies the delivery destination apparatus of incoming information in response to the instruction information in the registration unit when the electronic mail comes in. The notification unit sends received electronic mail in response to delivery request from the delivery destination apparatus, and inhibits sending of the electronic mail to the delivery destination apparatus before incoming information is sent out.

### CROSS-REFERENCE TO RELATED APPLICATIONS

This application is a continuation of International Application No. PCT/JP2005/005889, filed on Mar. 29, 2005, now pending, herein incorporated by reference.

### BACKGROUND OF THE INVENTION

1. Field of the Invention

The present invention relates to an electronic mail server apparatus used for sending and receiving electronic mail via computer networks such as the Internet; and specifically to an electronic mail server apparatus that reduces a load of mail delivery toward a client apparatus, a client apparatus, an incoming mail notification method and an incoming mail notification program.

2. Description of the Related Art

Electronic mail is widely used in information communication via computer networks such as the Internet. Using electronic mail greatly improves the efficiency of information transmission. Generally, many client personal computers (PC) are connected to an electronic mail server apparatus. Electronic mail is sent and delivered between client PCs via an electronic mail server apparatus.

Concerning the electronic mail server apparatus, electronic mail protocols are used in sending and receiving electronic mail. SMTP (Simple Mail Transfer Protocol) is used as a transfer protocol in sending electronic mail. In this case, an SMTP server is used as a sending server. POP3 (Post Office Protocol version 3) is used for example, as a receiving protocol in receiving electronic mail and in this case, a POP3 server is used as a receiving server. Processes that whether electronic mail arrives from client PCs to a receiving server is contacted toward the receiving server, and incoming mail is taken into the client PCs are executed.

About such processes of electronic mail delivery, for example as shown in FIG. 1, an electronic mail delivery server apparatus 100 is disposed on a side of a network such as the Internet. Many client PCs 301, 302 . . . 30N are connected to the electronic mail delivery server apparatus 100 via an electronic mail server apparatus 200. Mail is delivered from the electronic mail server apparatus 200 to one or not less than two of the client PCs 301, 302 . . . 30N.

In the processes of electronic mail delivery, between the client PCs 301 to 30N and electronic mail server apparatus 200, in case that there is no incoming mail, a series of processes is executed that connection between the electronic mail server apparatus 200 and client PCs 301 to 30N (step S201), notification of user names (step S202), notification of passwords (step S203), retrieval of the number of archived mails (step S204) and the end of a session (step S205). Such contact of mail arrival is repeated at regular time intervals regardless of whether incoming mail is present.

If mail is delivered from the electronic mail delivery server apparatus 100 to the electronic mail server apparatus 200 (step S206), the mail is archived in the electronic mail server apparatus 200 (step S207). In case that there is incoming mail, a series of processes is executed that connection between the electronic mail server apparatus 200 and client PCs 301 to 30N (step S208), notification of the user names (step S209), notification of the passwords (step S210), taking the mail into the client PCs 301 to 30N (step S211), deletion of the mail in the electronic mail server apparatus 200 (step S212) and cutting of the connection (step S213).

Concerning such electronic mail server apparatus and mail receiving, there are conventional patent documents such as; Japanese Patent Application Laid-open Publication No. 2000-215119 that inserts data concerning selection of notification means of mail arrival into the mail and selects a notification method for incoming notification of mail arriving at a mail server apparatus (paragraph No. 0049, FIG. 1, etc.); Japanese Patent Application Laid-open Publication No. 2002-358271 that makes a mail server, etc. access at intervals designated by a user, and acquires and notifies information such as arrival time of incoming mail, the number of arrival mails and the number of unread mails (paragraph No. 0023, FIG. 1, etc.); Japanese Patent Application Laid-open Publication No. 2000-13433 that in mail arrival, transmits incoming notification information that represents incoming notification from a mail server (paragraph Nos. 0014, 0015, 0016, 0017, FIG. 4, etc.); and Japanese Patent Application Laid-open Publication No. H11-149434 that in mail arrival, identifies a mail address of a transmitter of mail and reports the mail arrival with an alarm tone, etc. (paragraph No. 0022, FIG. 1, etc.).

Electronic mail arriving at an electronic mail server apparatus is delivered to client PCs. It is necessary for mail delivery that client PCs access an electronic mail server apparatus. In case that a client PC accesses an electronic mail server apparatus several times and a plurality of client PCs access the apparatus, if the number of disposed client PCs is m and the number of times of accesses from each client PC is n, the number of times of accesses, which the electronic mail server apparatus receives, N is
N=m×n (1)
A load of the electronic mail server apparatus increases in proportion to the product of the number of the client PCs and the number of the accesses from each client PC, (m×n).

In order to know at mail arrival rapidly, the client PCs access the electronic mail server apparatus at regular time intervals. The ratio that the accesses hit incoming mail is low toward the number of times of accesses n. The lower the ratio is, the more there are vain accesses. If a client PC accesses the apparatus at intervals of one minute, the number of times of accesses n per day is
n=24(hours)×60(minutes)=1440(times) (2)
Suppose electronic mail arrivals to the client PC are 60 (mails) per day, the ratio of the number of hitting q to the number of accesses n per day, q/n (%), is
q/n=(60/1440)×100=(1/24)×100≈4(%) (3)
So, 96 (%) of the number of accesses n are vain accesses.

Receiving accesses from connected client PCs, the electronic mail server apparatus is burdened considerably.

Suppose time t, which the electronic mail server apparatus needs for one process of checking mail, is t=1/100 (seconds). If the number of disposed client PCs m is m=10,000, all time of the process thereof Ta is
Ta=t×m×(q/n) =1/100(seconds)×10,000×0.96 =96(seconds) (4)
The electronic mail server apparatus takes the vain time 96 (seconds) to execute the process with a load.

### SUMMARY OF THE INVENTION

An object of the present invention relates to an electronic mail server apparatus used for sending and receiving electronic mail; and is to reduce a load toward an electronic mail server apparatus.

To achieve the above object, an electronic mail server apparatus of the present invention there is provided an electronic mail server apparatus that sends and receives electronic mail, the apparatus comprising a registration unit that registers instruction information notified from a delivery destination apparatus of the electronic mail; and a notification unit that notifies incoming information to the delivery destination apparatus in response to the instruction information in the registration unit in case that the electronic mail arrives.

According to such structure, instruction information from the delivery destination apparatus is registered in the registration unit. When mail arrives, instruction information in the registration unit is retrieved. On the basis of the retrieved instruction information, incoming information is notified from the notification unit to the delivery destination apparatus. Corresponding to sending of delivery request of the electronic mail from the delivery destination apparatus having received the incoming information, the electronic mail is delivered. Thus, the electronic mail server apparatus is released from managing of regular accesses from the delivery destination apparatus and a load thereof are attempted to reduce.

To achieve the above object, in the electronic mail server apparatus, the notification unit may send the received electronic mail in response to delivery request from the delivery destination apparatus and may inhibit sending of electronic mail to the delivery destination apparatus before the incoming information is sent out. As described, in case that the instruction information is sent from the delivery destination apparatus, the incoming information to the delivery destination apparatus is transmitted on the basis of the mail arriving. Before the incoming information is sent out, sending of the electronic mail to the delivery destination apparatus is inhibited. As a result, a load of the electronic mail server apparatus is attempted to reduce.

To achieve the above object, the electronic mail server apparatus may comprise a mail archive unit that archives electronic mail, wherein electronic mail sent to the delivery destination apparatus is deleted from the mail archive unit after the sending. According to such structure, electronic mail delivered from a network is archived in the mail archive unit. After electronic mail is delivered to the delivery destination apparatus sending delivery request, the electronic mail is deleted from the mail archive unit. Timing of deleting the electronic mail is synchronized with the mail delivery, for example. Thus, time of archiving of the electronic mail archived in the mail archive unit is limited to the short time from the mail delivery from the network, notification of the incoming information, the delivery request from the delivery destination apparatus to the mail delivery. Because the delivered electronic mail is not left in the mail archive unit and electronic mail server apparatus, the risk of leak is prevented and the function of security is strengthened.

To achieve the above object, according to an electronic mail server apparatus of the present invention there is provided an electronic mail server apparatus that is connected to a plurality of delivery destination apparatuses and delivers electronic mail to the delivery destination apparatuses, the electronic mail server apparatus, the electronic mail server apparatus comprising a registration unit that registers information showing whether the delivery destination apparatus receives incoming notification from the electronic mail server apparatus or not, concerning each of the plurality of delivery destination apparatus; and a control unit that, if electronic mail to a delivery destination apparatus is arrived, sends incoming notification to the delivery destination apparatus in case where information that the delivery destination apparatus receives incoming notification is registered in the registration unit, the control unit delivering the electronic mail to the delivery destination apparatus in case that delivery request on the incoming notification is received from the delivery destination apparatus.

According to such structure, if there is registration information of wanting to receive incoming notification in the registration unit, when electronic mail arrives, incoming notification thereof is sent to the delivery destination apparatus. In case that delivery request is received from the delivery destination apparatus, the electronic mail can be delivered to the delivery destination apparatus concerning the delivery request.

To achieve the above object, according to a client apparatus of the present invention there is provided a client apparatus that is connected to an electronic mail server apparatus, the client apparatus comprising a control unit that sends information requesting to send incoming notification to the client apparatus to the electronic mail server apparatus in case that mail arrives at the electronic mail server apparatus, the control unit sending delivery request of incoming mail to the electronic mail server apparatus in case that the incoming notification is received from the electronic mail server apparatus.

According to such structure, when mail arrives from the client apparatus to the electronic mail server apparatus, the request of wanting to receive the incoming notification is sent. On the basis of the request, the information of wanting to receive the incoming notification is registered in the described electronic mail server apparatus. The client apparatus sends the delivery request of the incoming mail to the electronic mail server apparatus when the incoming notification is received from the electronic mail server apparatus. This enables the client apparatus to receive mail delivery, to be released from accesses to the electronic mail server apparatus regardless of the presence of mail delivery; and to reduce a load thereof.

To achieve the above object, according to an incoming mail notification method of an electronic mail server apparatus of the present invention there is provided an incoming mail notification method of an electronic mail server apparatus that sends and receives electronic mail, the method comprising the processes of registering instruction information notified from a delivery destination apparatus of the electronic mail in a registration unit; and notifying incoming information to the delivery destination apparatus according to the instruction information in the registration unit, with taking arrival of the electronic mail as an opportunity.

According to such structure, instruction information from the delivery destination apparatus is registered in the registration unit. When mail arrives, instruction information in the registration unit is retrieved. On the basis of the retrieved instruction information, incoming information is notified to the delivery destination apparatus. In response to delivery request of the electronic mail sent from the delivery destination apparatus which has received the incoming information, the electronic mail is delivered. Thus, there is no unrelated access with mail arrival from the delivery destination apparatus and a load of the electronic mail server apparatus is attempted to reduce.

To achieve the above object, the incoming mail notification method of the electronic mail server apparatus may comprise the processes of sending the received electronic mail according to delivery request from the delivery destination apparatus; and inhibiting delivery of electronic mail to the delivery destination apparatus before the incoming information is sent out.

To achieve the above object, the incoming mail notification method of the electronic mail server apparatus may comprise the process of deleting electronic mail in a mail archive unit therefrom after sending the mail to the delivery destination apparatus.

To achieve the above object, according to an incoming mail notification program of an electronic mail server apparatus of the present invention there is provided an incoming mail notification program of an electronic mail server apparatus that sends and receives electronic mail, the program being executed by a computer, the program comprising the steps of registering instruction information notified from a delivery destination apparatus of the electronic mail in a registration unit; and notifying incoming information to the delivery destination apparatus on the basis of the instruction information, with taking mail arrival as an opportunity.

According to such structure, instruction information from the delivery destination apparatus is registered in the registration unit, and the instruction information in the registration unit is retrieved in response to mail arrival. On the basis of the instruction information, incoming information is notified to the delivery destination apparatus. In response to delivery request of the electronic mail sent from the delivery destination apparatus which has received the incoming information, the electronic mail is delivered.

To achieve the above object, the incoming mail notification program of the electronic mail server apparatus may comprise the steps of sending the received electronic mail according to delivery request from the delivery destination apparatus; and inhibiting delivery of electronic mail to the delivery destination apparatus before the incoming information is sent out.

To achieve the above object, the incoming mail notification program of the electronic mail server apparatus may comprise the step of deleting electronic mail in a mail archive unit therefrom after sending the mail to the delivery destination apparatus from which delivery request is sent.

Features and advantages of the present invention are listed as follows.

(1) Because mail arrival is notified from an electronic mail server apparatus to a delivery destination apparatus, contact from the delivery destination apparatus to the electronic mail server apparatus is not necessary regardless of the presence of mail arrival. It is attempted to reduce a load of the electronic mail server apparatus and a load of the delivery destination apparatus (a client apparatus).

(2) Because mail arrival notification to the delivery destination apparatus can be synchronized with the mail arrival, time lag between mail arrival to the electronic mail server apparatus and mail receiving of the delivery destination apparatus becomes small; and the rapidness of electronic mail notification can be improved.

(3) If just after mail arrival notification to the delivery destination apparatus, electronic mail is taken into the delivery destination apparatus from the electronic mail server apparatus to be deleted from the mail archive unit, the amount of remaining electronic mail toward the mail archive unit of the electronic mail server apparatus can be reduced and the volume of the mail archive unit can be shrunk.

(4) If just after mail arrival notification to the delivery destination apparatus, electronic mail is taken into the delivery destination apparatus from the electronic mail server apparatus to be deleted from the mail archive unit, residence time of electronic mail in the electronic mail server apparatus becomes short. The structure can contribute to the prevention of leaking information of electronic mail.

Other objects, features, and advantages of the present invention will be understood more clearly by referring to the accompanying drawings and embodiments.

### BRIEF DESCRIPTION OF THE DRAWINGS

FIG. 1 depicts a sequence of electronic mail delivery processes in a conventional electronic mail delivery system;

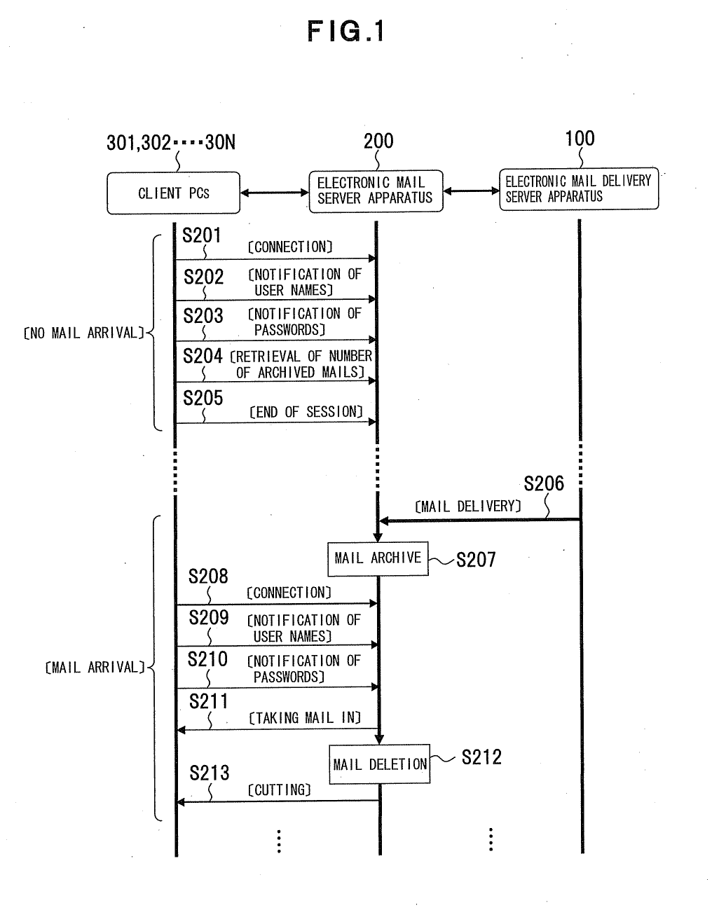

FIG. 2 is block diagram showing an electronic mail delivery system according to an embodiment of the present invention;

FIG. 3 depicts an example of concrete configuration of an electronic mail delivery system;

FIG. 4 depicts a sequence of mail delivery processes in an electronic mail delivery system;

FIG. 5 is a flowchart showing processes in an electronic mail delivery system;

FIG. 6 is a flowchart showing processes of a client PC;

FIG. 7 is a flowchart showing processes of a client PC;

FIG. 8 is a flowchart showing processes of an electronic mail server apparatus; and

FIG. 9 is a flowchart showing processes of an electronic mail server apparatus.

### DETAILED DESCRIPTION OF THE PREFERRED EMBODIMENTS

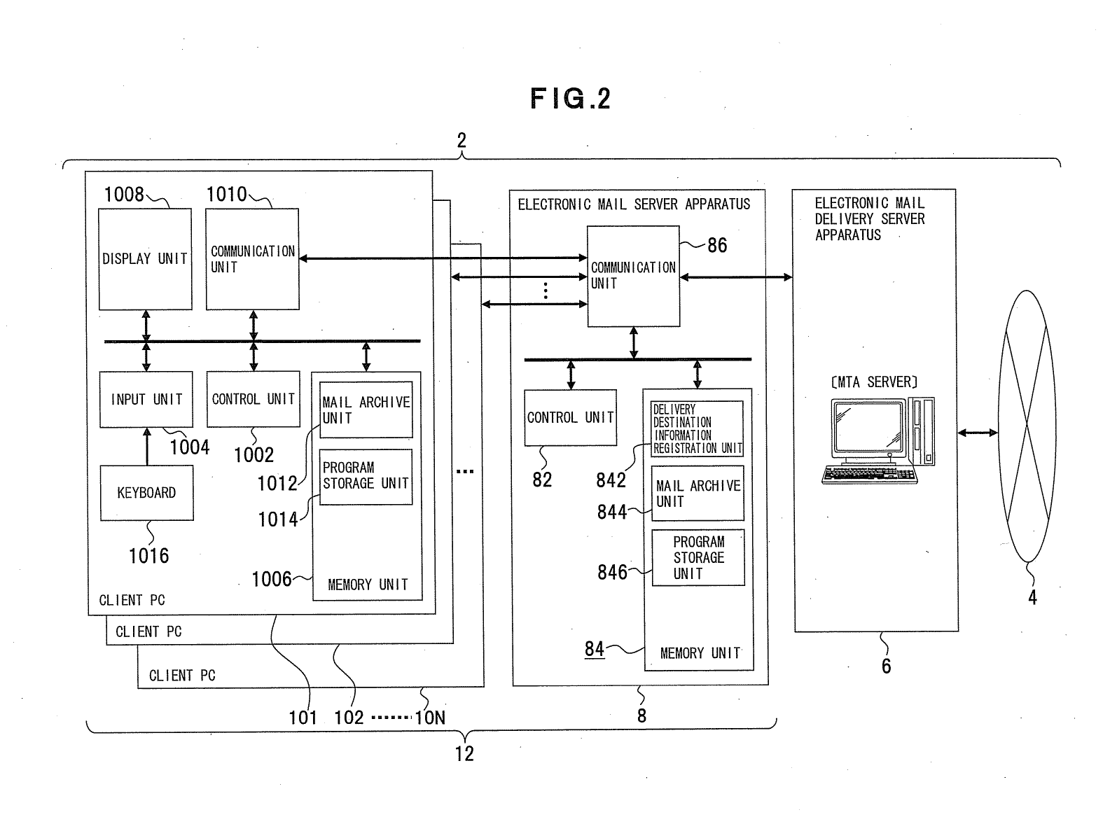

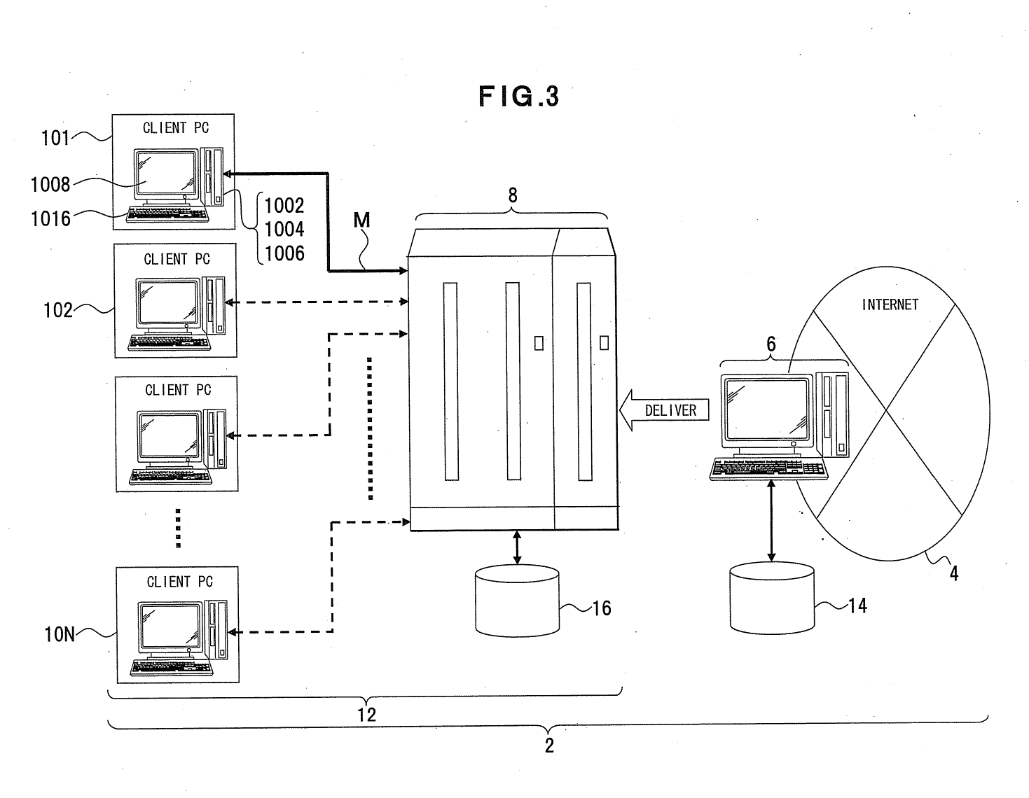

An embodiment of the present invention will be described with reference to FIGS. 2 and 3. FIG. 2 is blocks showing an electronic mail delivery system that is an embodiment of the present invention; and FIG. 3 depicts an example of concrete structure of an electronic mail delivery system.

This electronic mail delivery system 2, for example, includes the Internet 4, an electronic mail delivery server apparatus 6, an electronic mail server apparatus 8 and client personal computers (PCs) 101, 102 . . . 10N. The Internet 4 is one example and any network will be permitted if that is a computer network. The electronic mail delivery server apparatus 6 is composed of computers; and executes software, for example, an MTA (Message Transfer Agent) server delivering electronic mail in the Internet 4. The client PCs 101, 102 . . . 10N are client apparatuses sending and receiving information by connecting with the electronic mail server apparatus 8, and are also delivery destination apparatuses receiving delivery of information such as electronic mail.

In the embodiment, while the electronic mail delivery server apparatus 6 is connected with the Internet 4, the electronic mail server apparatus 8 is connected with a plurality of client PCs 101, 102 . . . 10N. In other words, the electronic mail server apparatus 8 and the client PCs 101, 102 . . . 10N compose an intranet; and the electronic mail server apparatus 8 composes an interface apparatus to connect an intranet 12 and the Internet 4. The electronic mail server apparatus 8 sends and receives electronic mail to and from the electronic mail delivery server apparatus 6; and sends and receives electronic mail to and from the client PCs 101, 102 . . . 10N. Each client PC 101, 102 . . . 10N composes a delivery destination apparatus of electronic mail toward the electronic mail server apparatus 8.

The electronic mail server apparatus 8 is provided with a control unit 82, a memory unit 84 and a communication unit 86. The memory unit 84 is provided with a delivery destination information registration unit 842, a mail archive unit 844, a program storage unit 846, etc. In such structure, the control unit 82 is composed of a CPU (Central Processing Unit), a cache memory, etc. The control unit 82 performs processes such as sending and receiving of electronic mail by executing a mail delivery program, etc. stored in the program storage unit 846.

The memory unit 84 is, for example, composed of a hard disc device, etc. The delivery destination information registration unit 842 stores instruction information notified from the client PCs 101, 102 . . . 10N that are delivery destination apparatuses, and delivery destination information such as user ID representing each client PC 101, 102 . . . 10N and password thereof. Instruction information notified from the client PCs 101, 102 . . . 10N is information of requesting notification of electronic mail arrival to the electronic mail server apparatus 8 and after the request, cancelling accesses for incoming confirmation. The mail archive unit 844 stores and archives various pieces of electronic mail such as electronic mail delivered from the electronic mail delivery server apparatus 6 and electronic mail sent from the client PCs 101, 102 . . . 10N. The program storage unit 846 stores a mail delivery program, communication protocols and various control programs. As the programs of the communication protocols, etc. stored in the program storage unit 846, a communication protocol to forward Internet mail, for example an SMTP (Simple Mail Transfer Protocol) server and a protocol to take arrived electronic mail in the client PC, for example a POP3 (Post Office Protocol version 3) server are stored. In processes of the mail delivery program, the electronic mail server apparatus 8, which receives instruction information from the client PCs 101, 102 . . . 10N that are delivery destination apparatuses of electronic mail, inhibits sending out the electronic mail to the client PCs 101, 102 . . . 10N until incoming notification of the electronic mail is sent out to the client PCs 101, 102 . . . 10N.

The communication unit 86 is connected to the electronic mail delivery server apparatus 6 and the client PCs 101, 102 . . . 10N. The communication unit 86 sends and receives electronic mail and information except electronic mail to and from the electronic mail delivery server apparatus 6 and/or each client PC 101, 102 . . . 10N by control of the control unit 82. That is, the communication unit 86 composes a notification unit of delivery notification toward one or not less than two of the client PCs 101, 102 . . . 10N on the basis of instruction information notified from the client PCs 101, 102 . . . 10N. Instruction information and delivery destination information such as user IDs and passwords that are notified from the client PCs 101, 102 . . . 10N are received by the communication unit 86 to be registered in the delivery destination information registration unit 842 in the memory unit 84.

Each client PC 101, 102 . . . 10N is composed of a control unit 1002, an input unit 1004, a memory unit 1006, a display unit 1008, a communication unit 1010, etc. The memory unit 1006 is composed of a hard disc device, etc. and a mail archive unit 1012, a program storage unit 1014, etc. are provided. In such structure, the control unit 1002 is composed of a CPU, a cache memory, etc. and executes processes of sending and receiving of electronic mail, etc. by the performance of a mail delivery program, etc. stored in the program storage unit 1014. In this case, the client PC 101, 102 . . . 10N which notifies instruction information of receiving incoming notification to the electronic mail server apparatus 8 stops accesses of taking electronic mail in until the incoming notification is received.

A keyboard 1016 and a mouse, etc. are, for example, connected to the input unit 1004. By key input operation, etc., information is inputted. The display unit 1008 is, for example, composed of an LCD (Liquid Crystal Display), etc. and displays electronic mail to send and received electronic mail.

The communication unit 1010 is connected to the communication unit 86 of the electronic mail server apparatus 8. The communication unit 1010 sends and receives electronic mail and information except electronic mail to and from the electronic mail server apparatus 8, transmits instruction information toward the electronic mail server apparatus 8 and delivery destination information such as an user ID and a password, which each client PC 101, 102 . . . 10N has, to the communication unit 86 of the electronic mail server apparatus 8 or receives mail arrival notification as incoming information of electronic mail from the electronic mail server apparatus 8 by control of the control unit 1002. Here, instruction information toward the electronic mail server apparatus 8 includes the information instructing the electronic mail server apparatus 8 to receive incoming notification when electronic mail arrives to the electronic mail server apparatus 8, and to execute receiving of the electronic mail after the incoming notification. Sending and receiving information except electronic mail include sending of deletion instruction of electronic mail in the mail archive unit 844 from each client PC 101, 102 . . . 10N.

In the memory unit 1006, the mail archive unit 1012 archives electronic mail which should be sent and received electronic mail. The program storage unit 1014 stores a documents, etc. creation program, a mail sending and receiving program, etc.

Such electronic mail delivery system 2 is composed as shown in FIG. 3. In this case, a database unit 14 is disposed in the electronic mail delivery server apparatus 6 and a database unit 16 is disposed in the electronic mail server apparatus 8. Such storage units may be disposed to archive mail, etc.

In such electronic mail delivery system 2, instruction information of receiving incoming notification in case of mail arrival is notified from the client PCs 101, 102 . . . 10N to the electronic mail server apparatus 8. If the information is registered in the delivery destination information registration unit 842, there is no access for the mail receiving from the client PCs 101, 102 . . . 10N; and arrival of incoming notification M from the electronic mail server apparatus 8 is waited. The electronic mail server apparatus 8 does not deliver the electronic mail after incoming notification M of the electronic mail is sent out. In an example in FIG. 3, incoming notification M is sent out to the client PC 101. In response to the sending out, the electronic mail is taken into the client PC 101 from the electronic mail server apparatus 8.

As described above, the electronic mail server apparatus 8 receives instruction information of wanting to receive mail incoming notification from the client PCs 101, 102 . . . 10N, registers the information in the delivery destination information registration unit 842, executes incoming notification to each client PC 101, 102 . . . 10N when mail arrives, and receives accesses of taking the electronic mail in just after the incoming notification. A load of the electronic mail server apparatus 8 reduces and accesses of contact is not necessary, so loads of the client PCs 101, 102 . . . 10N also reduce. If the electronic mail stored in the mail archive unit 844 of the electronic mail server apparatus 8 is deleted after taking the electronic mail in from the client PCs 101, 102 . . . 10N ends, the memory of the mail archive unit 844 can reduce, and also, the residence time of the electronic mail toward the electronic mail server apparatus 8 becomes short. The deletion contributes to prevention of leaking information and improvement of security function.

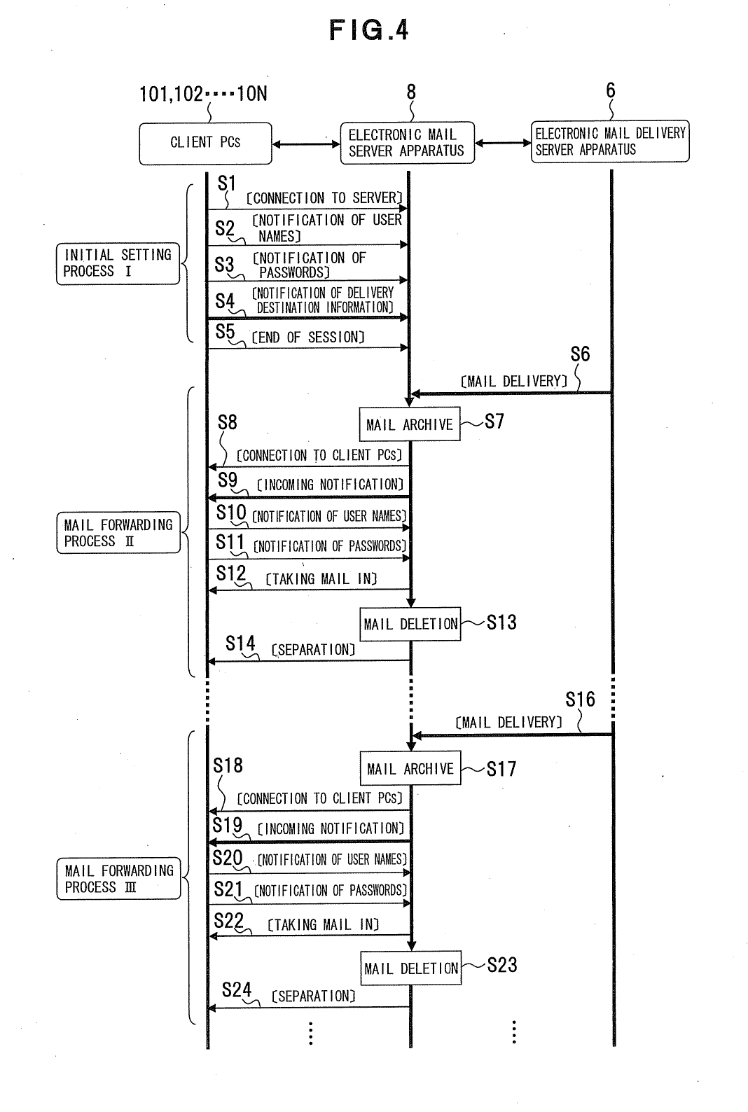

A mail delivery process will be described with reference to FIG. 4. FIG. 4 depicts a sequence of processes for mail delivery and a summary of the contents of the processes.

Before execution of these mail delivery processes, an initial setting process I is executed between each client PC 101, 102 . . . 10N and the electronic mail server apparatus 8. Expediently, the client PC 101 is used for explanation as an example. In the initial setting process I, the client PC 101 is connected to the electronic mail server apparatus 8 (step S1); and user names are notified (step S2), passwords are notified (step S3) and delivery destination information is notified (step S4) from the client PC 101 to execute session's ending (step S5). By the initial setting, accesses of contact from the client PC 101 is cancelled and mail is not delivered until the electronic mail server apparatus 8 sends out incoming notification, concerning electronic mail delivery between the client PC 101 and the electronic mail server apparatus 8.

After such initial setting process, a mail forwarding process II is executed. After mail is delivered from the electronic mail delivery server apparatus 6 to the electronic mail server apparatus 8 (step S6), the incoming electronic mail is archived in the mail archive unit 844 of the electronic mail server apparatus 8 (step S7). The electronic mail server apparatus 8 retrieves registration information of the delivery destination information registration unit 842 about delivery destination information included in the received electronic mail, selects an applicable delivery destination and reads out instruction information. In this case, because in the client PC 101, which is a delivery destination of the electronic mail, the described initial setting is executed, the electronic mail server apparatus 8 is connected to the client PC 101 (step S8) and incoming notification is sent out (step S9). In the client PC 101 receiving the incoming notification, after notification of the user names (step S10) and notification of the passwords (step S81), the electronic mail archived in the mail archive unit 844 is taken in (step S12). In the taking of the mail in, the client PC 101 sends out instruction of mail deletion. On the basis of the instruction, the mail is deleted in the electronic mail server apparatus 8 (step S13). After this process, the electronic mail server apparatus 8 and the client PC 101 are separated (step S14) and shift to a state of waiting.

In case that mail delivery is occurred again, a mail forward process III as well as the mail forward process II described above is executed. After mail is delivered from the electronic mail delivery server apparatus 6 to the electronic mail server apparatus 8 (step S16), the incoming electronic mail is archived in the mail archive unit 844 of the electronic mail server apparatus 8 (step S17). The electronic mail server apparatus 8 retrieves registration information of the delivery destination information registration unit 842 about delivery destination information included in the received electronic mail, selects an applicable delivery destination and read out instruction information. In this case, because in the client PC 101, which is a delivery destination of the electronic mail, the described initial setting is executed, the electronic mail server apparatus 8 is connected to the client PC 101 (step S18) and incoming notification is sent out (step S19). In the client PC 101 receiving the incoming notification, after the user names are notified (step S20) and the passwords are notified (step S21), the electronic mail archived in the mail archive unit 844 is taken in (step S22) In the taking of the mail in, the client PC 101 sends out instruction of mail deletion and on the basis of the sending out, the mail is deleted in the electronic mail server apparatus 8 (step S23). After this process, the electronic mail server apparatus 8 and the client PC 101 are separated (step S24) and shift to a state of waiting.

Repeat of such processes delivers mail. The client PCs 102 . . . 10N can also be applied to the above described mail delivery with setting of registering delivery destination information to receive mail delivery after receiving incoming notification by the initial setting process to the electronic mail server apparatus 8. In this case, in the electronic mail server apparatus 8, because there is no contact from the client PCs 101, 102 . . . 10N in which delivery destination information is registered, a load thereof reduce. And, because archive and deletion of mail are executed one after another, the area of electronic mail archive becomes narrow to be attempted to reduce.

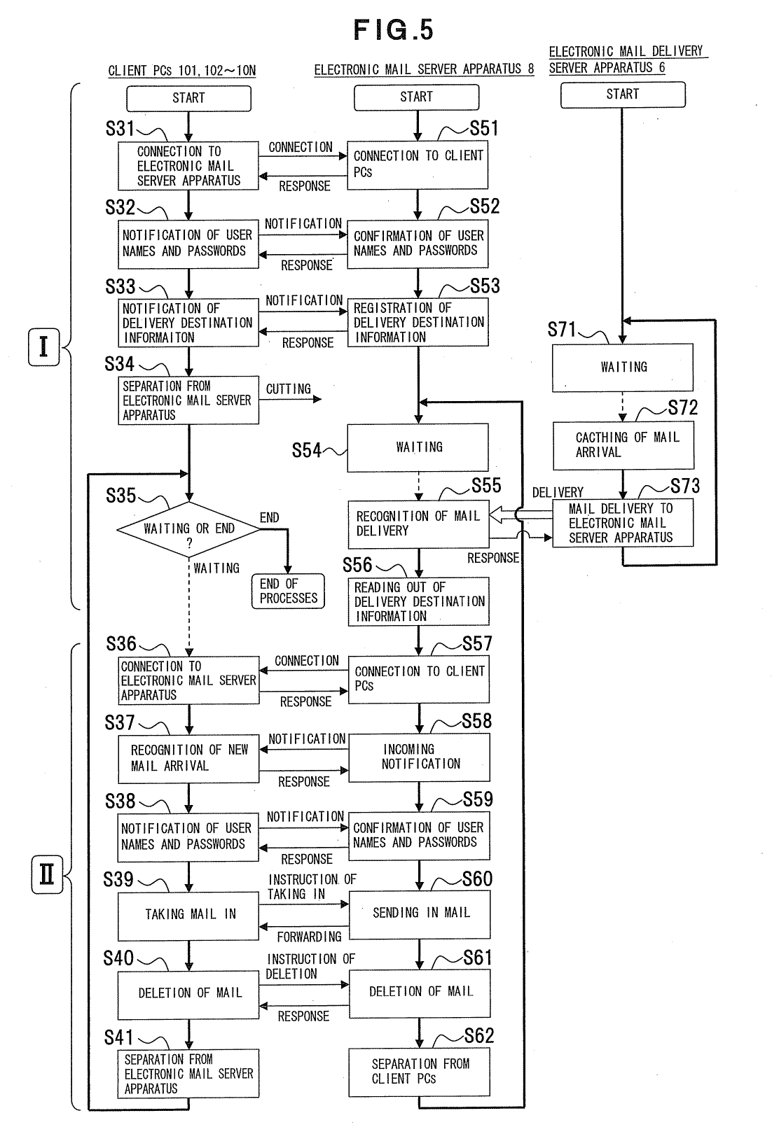

Mail delivery processes will be in detail described with reference to FIG. 5. FIG. 5 is a flowchart showing mail delivery processes. In FIG. 5, I corresponds to the initial setting processes I in FIG. 4 and II corresponds to the mail forwarding process II in FIG. 4.

In the client PCs 101, 102 . . . 10N, a series of processes is executed. That is, as the initial setting process I described above, connection with the electronic mail server apparatus 8 (step S31) , notification of user names and passwords to the electronic mail server apparatus 8 (step S32) notification of delivery destination information (step S33) and separation from the electronic mail server apparatus 8 (step S34) In the processes, an user name and a password are set by each client PC 101, 102 . . . 10N and delivery destination information is set by each client PC 101, 102 . . . 10N that is a delivery destination apparatus. The delivery destination information includes information that represents receiving delivery notification in response to receiving of electronic mail in the electronic mail server apparatus 8. The information is set by each client PC 101, 102 . . . 10N individually as described above. After the series of processes, whether waiting or end is confirmed in the client PCs (step S35). For example, when power supply of the client PCs is cancelled, the processes end, and when the power supply is maintained, the client PCs are maintained in states of waiting.

Toward such initial setting process I and the process of states of waiting in the client PCs, connection with the client PCs is executed corresponding to step S31 at the electronic mail server apparatus 8 side; and processes of maintenance of connection relationship and response execute between the connected electronic mail server apparatus 8 and the client PCs (step S51). Corresponding to step S32, the user names and the passwords notified from the client PCs are confirmed (step S52). After the confirmation, response of ending authentication is notified to the client PCs. Corresponding to step S33, a registration process of the delivery destination information notified from the client PCs executes (step S53) ; and response of the registration is notified to the client PCs. The electronic mail server apparatus 8 reaches to a state of waiting (step S54).

The electronic mail delivery server apparatus 6 is in a state of waiting (step S71). On the basis of catching mail arrival (step S72), the mail is delivered to the electronic mail server apparatus 8 (step S73). By the mail delivery, response thereof is notified from the electronic mail server apparatus 8 to the electronic mail delivery server apparatus 6.

In response to the mail delivery, in the electronic mail server apparatus 8 maintained in the state of waiting (step S54), the mail delivery recognition is executed (step S55). In response to the recognition, according to the contents of the recognition, that is, according to mail delivery destination, the delivery destination information in the delivery destination information registration unit 842 is retrieved and the delivery destination information is read out (step S56). A client PC corresponding to the delivery destination information is connected (step S57) and incoming notification is sent out to the client PC (step S58). Corresponding to the incoming notification, after confirmation of user names and passwords notified from the client PC (step S59) , the mail is sent in (step S60). By deletion instruction from the client PC, the mail is deleted (step S61), the electronic mail server apparatus 8 is separated from the client PC (step S62) and the process returns to the state of waiting (step S54).

Processes corresponding to the processes in the electronic mail server apparatus 8 are executed in the client PC. That is, by connection with the electronic mail server apparatus 8 (step S36) , the client PC in the state of waiting maintains a state of the connection and responds, and the new mail arrival is recognized by the incoming notification from the electronic mail server apparatus 8 (step S37). From this, the user names and the passwords are notified to request the mail delivery to the electronic mail server apparatus 8 (step S38), taking the mail in from the electronic mail server apparatus 8 is instructed (step S39) and the mail taken in is archived in the mail archive unit 1012. After the taking mail in, the deletion of the mail from the client PC (step S40) is instructed to the electronic mail server apparatus 8, confirmation of the mail deletion and the response of the confirmation are notified from the electronic mail server apparatus 8 to the client PC and the client PC is separated from the electronic mail server apparatus 8 (step S41). By passing through such a series of processes, the client PC shifts in a state of waiting (step S35) and next arrival of incoming notification is waited.

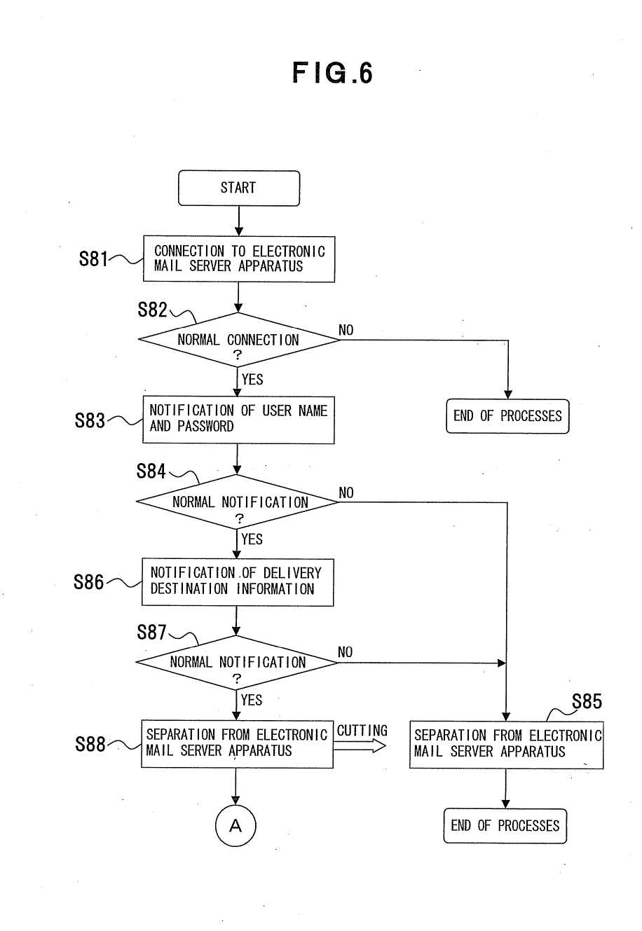

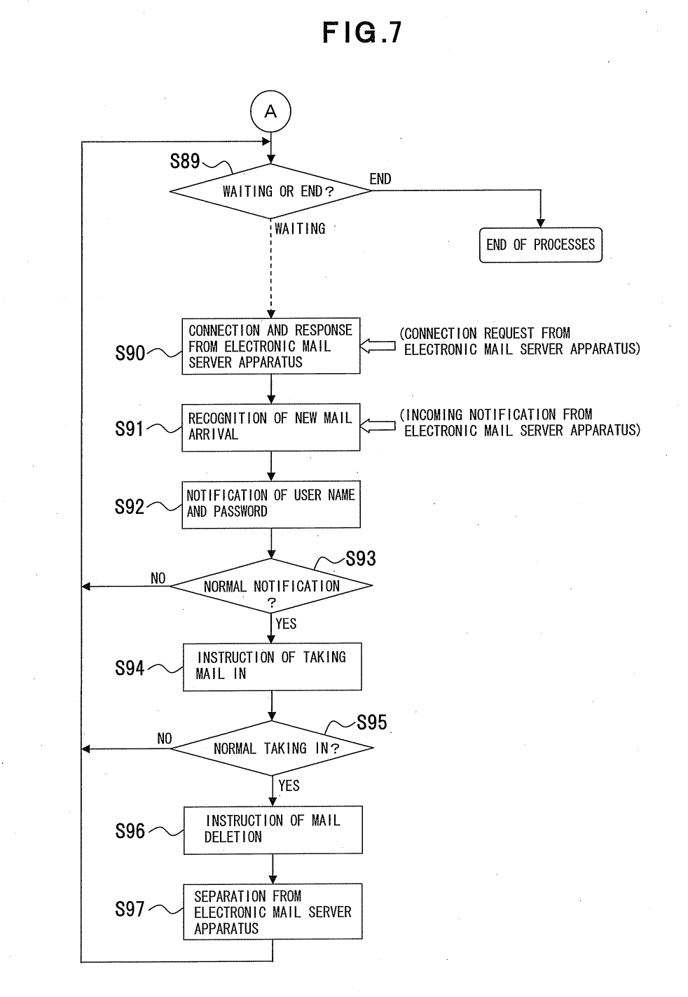

Processes of mail delivery in the client PCs 101, 102 . . . 10N will be described with reference to FIGS. 6 and 7. FIGS. 6 and 7 are flowcharts showing processes of mail delivery at the client PCs 101, 102 . . . 10N side. In FIGS. 6 and 7, A shows a connection part of flowcharts.

After any one of the client PCs 101, 102 . . . 10N starts up, for example, the client PC is connected to the electronic mail server apparatus 8 (step S81). After execution of a process of, the connection, whether the connection is normal or not is judged (step S82) In case that the client PC cannot be normally connected, the processes end. In case of normal connection, after notification of a user name and a password (step S83) , whether the user name and the password are normally notified or not is judged (step S84). Unless the user name and the password are normally notified, the client PC is separated from the electronic mail server apparatus 8 (step S85) and the processes end. Unless a normal authentication process is executed, a process of incoming notification corresponding incoming mail is inhibited.

In case that the user name and the password are normally notified, after notification of delivery destination information (step S86), whether the information is normally notified or not is judged (step S87) Unless the information is normally notified, the client PC is separated from the electronic mail server apparatus 8 (step S85) and the processes end. In case that the delivery destination information is normally notified, after the client PC is separated from the electronic mail server apparatus 8 (step S88) , whether waiting or end is judged (step S89). The waiting is that the client PC is maintained in an operation state and the end is that power supply of the client PC in operation is stopped, etc. The end brings the processes end.

In the state of waiting, if connection request is sent out from the electronic mail server apparatus 8, the electronic mail server apparatus 8 is connected and a response is made (step S90). The client PC receives incoming notification from the electronic mail server apparatus 8 and a process of recognition of mail arrival is executed (step S91). In the client PC receiving the incoming notification, the user name and the password are notified (step S92), whether the user name and the password are normally notified or not is judged (step S93) and if the user name and the password are not normally notified, the process returns to step S89. In case that the user name and the password are normally notified, taking the mail in is instructed (step S94) and the new incoming mail is taken in. About the new incoming mail, whether the mail is normally taken in or not is judged (step S95), unless the mail is normally taken in, the process returns to step S89. In case of taking the mail in normally, toward the electronic mail server apparatus 8, deletion of the mail is instructed (step S96) and the client PC is separated from the electronic mail server apparatus 8 (step S97).

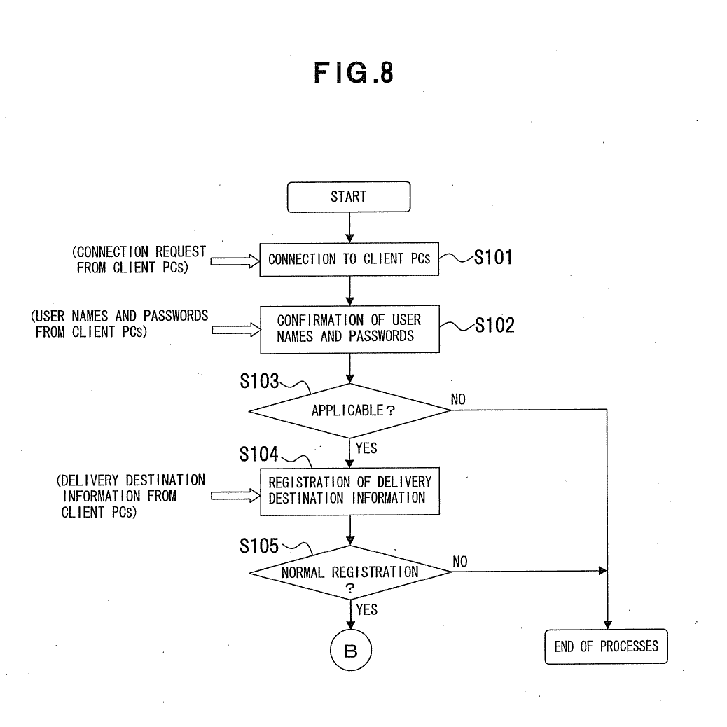

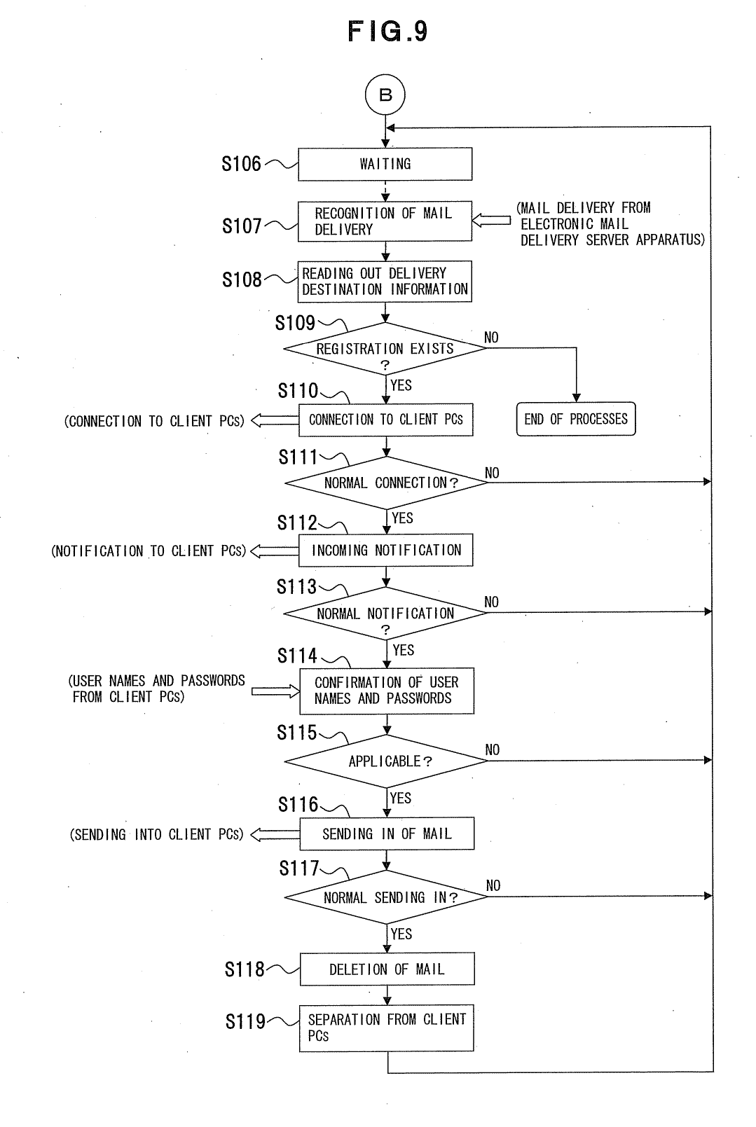

Processes of mail delivery in the electronic mail server apparatus 8 will be described with reference to FIGS. 8 and 9. FIGS. 8 and 9 are flowcharts showing processes of mail delivery in the electronic mail server apparatus 8. In FIGS. 8 and 9, B shows a connection part of flowcharts.

The electronic mail server apparatus 8 is maintained in a state of waiting at all times. Receiving connection request from the client PCs, the electronic mail server apparatus 8 is connected to the client PCs (step S101). When user names and passwords are notified from the client PCs connected to the electronic mail server apparatus 8, the user names and the passwords are confirmed in the electronic mail server apparatus 8 (step S102). About result of the confirmation, whether the result is applicable or not is judged (step S103). Unless the result is applicable, the processes end. In case that the result is applicable, the electronic mail server apparatus 8 receives notification of delivery destination information from the client PCs and the delivery destination information is registered in the delivery destination information registration unit 842 (FIG. 2) (step S104). Whether the delivery destination information is normally registered or not is judged (step S105). Unless the information is normally registered, the processes end. The electronic mail server apparatus 8, which normally completes the registration of the delivery destination information, shifts in a state of waiting (step S106).

After receiving of mail delivery from the electronic mail delivery server apparatus 6, a process of recognition of the mail delivery (step S107) is executed. Taking this as an opportunity, delivery destination information is read out (step S108). Whether the delivery destination information is registered or not is judged (step S109). Unless the information is registered, the processes end, and in case that the information is registered, the electronic mail server apparatus 8 is connected to the client PCs (step S110). About the connection, whether the electronic mail server apparatus 8 is normally connected or not is judged (step S111). Unless the electronic mail server apparatus 8 is normally connected, the process returns to step S106 to be in the state of waiting, and in case that the electronic mail server apparatus 8 is normally connected, mail incoming notification is sent out to the client PCs (step S112). Whether the notification is normally sent out from the electronic mail server apparatus 8 to the client PCs or not is judged (step. S113). Unless the notification is normally sent out, the process returns to step S106 to be in the state of waiting, and in case that the notification is normally sent out, the electronic mail server apparatus 8 receives user names and passwords notified from the client PCs and the user names and the passwords are confirmed (step S114). Whether the user names and the passwords are applicable or not is judged (step S115); and if the user names and the passwords are applicable, the mail is sent into the client PCs (step S116). Whether the mail is normally sent in or not is judged (step S117); and if the incoming mail is normally sent out to the client PCs, the sent out electronic mail is deleted from the mail archive unit 844 (step S118). The electronic mail server apparatus 8 is separated from the client PCs (step S119) and the mail delivery is completed to return to step S106.

As described above, in the electronic mail delivery system 2, instead of contact at regular time intervals from each client PC 101, 102 . . . 10N to the electronic mail server apparatus 8, in case that mail is delivered from the electronic mail delivery server apparatus 6, incoming notification is sent out from the electronic mail server apparatus 8 to applicable one of the client PCs 101, 102 . . . 10N in taking occasion. To receive such incoming notification, delivery destination information is registered in the electronic mail server apparatus 8 from the client PCs 101, 102 . . . 10N in advance in order that the electronic mail server apparatus 8 receives the incoming notification. Taking mail delivery as an opportunity, delivery destination information thereof is retrieved. When existence of the delivery destination information is confirmed, incoming notification is notified from the electronic mail server apparatus 8 to the client PCs 101, 102 . . . 10N on the instant. While mail does not arrive, contact from the client PCs 101, 102 . . . 10N is inhibited. This attempts to reduce a load of the electronic mail server apparatus 8. After completion of taking incoming mail in the client PCs 101, 102 . . . 10N, the electronic mail is deleted from the mail archive unit 844 of the electronic mail server apparatus 8 to be attempted to reduce memory capacity of the mail archive unit 844.

Concrete Example

An example of the present invention, which uses, for example POP3 (Post Office Protocol version 3) as a receiving protocol of the electronic mail server apparatus 8, will be described.

This POP3 protocol can be composed like that incoming notification is sent out from the electronic mail server apparatus 8 to the client PCs 101, 102 . . . 10N when new incoming mail and messages thereof are delivered from the electronic mail delivery server apparatus 6 by setting functions of an infm command and an info command. Procedures are as follows.

(1) The client PCs 101, 102 . . . 10N are connected to the electronic mail server apparatus 8 by a telnet command.

(2) A receiving mail address is notified by a user command and a pass command.

(3) A name of the client PCs 101, 102 . . . 10N (e.g. a name of a terminal or an IP address) , where incoming notification is notified when new incoming mail is delivered, is registered by an info command.

(4) After the registration, the connection between the client PCs 101, 102 . . . 10N and the electronic mail server apparatus 8 is separated.

(5) Notification of new incoming mail is waited (waiting).

(6) In arrival of new incoming mail, an applicable client PC of the client PCs 101, 102 . . . 10N is connected from the electronic mail server apparatus 8 by the telnet command; and incoming notification is sent by an infm command.

(7) In this case, in case that the incoming notification cannot be received because power is not supplied to the client PC, etc., the incoming mail is archived in the electronic mail server apparatus 8.

(8) After the incoming notification, the mail is taken in the client PC 101, 102 . . . 10N by a retr command. Because the incoming mail is taken in immediately, the residence time of the electronic mail server apparatus 8 is short, and it can be prevented that the mail is taken in other client PCs.

(9) The electronic mail in the electronic mail server apparatus 8 is deleted. The connection between the client PC receiving the mail delivery and the electronic mail server apparatus 8 is separated.

By such processes, just after mail arrival, the mail is delivered continuously after incoming notification of the electronic mail. The delivered electronic mail is deleted from the electronic mail server apparatus 8.

Other Embodiments

(1) Depending on a receiving program of electronic mail of the client PCs 101, 102 . . . 10N, there is a case that incoming notification from the electronic mail server apparatus 8 cannot be received from the time when power supplies. Even in such case, incoming mail is archived in the mail archive unit 844 in the electronic mail server apparatus 8, so the incoming mail does not disappear. In this case, it may be constituted that, to the client PCs which cannot receive the incoming notification from the electronic mail server apparatus 8, the incoming notification is sent again in proper time.

(2) The above embodiment explained that the electronic mail delivery server apparatus 6 is disposed in the Internet 4 and the electronic mail server apparatus 8 is in the intranet 12. It may be constituted that functions of the electronic mail delivery server apparatus 6 are unified into the electronic mail server apparatus 8 to configure one or a plurality of computers, and the electronic mail server apparatus 8 is organized in the Internet 4. To cut a long story short, the present invention is not limited to formation of a network.

Though the description has been given for the preferred embodiments of the present invention as above, the above description does not limit the present invention. Those skilled in the art can surely make various modifications and changes to the present invention based on the purview of the present invention described in claims or disclosed in the preferred embodiments for implementing the present invention. The modifications and changes are surely encompassed in the scope of the present invention.

The present invention relates to mail delivery of an electronic mail server apparatus. Because, in case of mail arrival, the arrival is notified to a delivery destination apparatus and taking electronic mail in from the delivery destination apparatus receiving the notification is permitted; the electronic mail server apparatus is released from repeat of a vain contact process, a load thereof is reduced, the volume of mail archive decreases and the residence time of mail at the electronic mail server apparatus becomes short, etc. So, the present invention is useful.

What is claimed is:

1. An electronic mail server apparatus that sends and receives electronic mail, the apparatus comprising:
a registration unit that registers instruction information notified from a delivery destination apparatus of the electronic mail; and
a notification unit that notifies incoming information to the delivery destination apparatus in response to the instruction information in the registration unit in case that the electronic mail arrives.

2. The electronic mail server apparatus of claim 1, wherein
the notification unit sends the received electronic mail in response to delivery request from the delivery destination apparatus, and inhibits sending of electronic mail to the delivery destination apparatus before the incoming information is sent out.

3. The electronic mail server apparatus of claim 1, comprising:
a mail archive unit that archives electronic mail,
wherein electronic mail sent to the delivery destination apparatus is deleted from the mail archive unit after the sending.

4. An electronic mail server apparatus that is connected to a plurality of delivery destination apparatuses and delivers electronic mail to the delivery destination apparatuses, the electronic mail server apparatus comprising:
a registration unit that registers information showing whether the delivery destination apparatus receives incoming notification from the electronic mail server apparatus or not, concerning each of the plurality of delivery destination apparatus; and
a control unit that, if electronic mail to a delivery destination apparatus is arrived, sends incoming notification to the delivery destination apparatus in case where information that the delivery destination apparatus receives incoming notification is registered in the registration unit, the control unit delivering the electronic mail to the delivery destination apparatus in case that delivery request on the incoming notification is received from the delivery destination apparatus.

5. A client apparatus that is connected to an electronic mail server apparatus, the client apparatus comprising:
a control unit that sends information requesting to send incoming notification to the client apparatus to the electronic mail server apparatus in case that mail arrives at the electronic mail server apparatus, the control unit sending delivery request of incoming mail to the electronic mail server apparatus in case that the incoming notification is received from the electronic mail server apparatus.

6. An incoming mail notification method of an electronic mail server apparatus that sends and receives electronic mail, the method comprising the processes of:
registering instruction information notified from a delivery destination apparatus of the electronic mail in a registration unit; and
notifying incoming information to the delivery destination apparatus according to the instruction information in the registration unit, with taking arrival of the electronic mail as an opportunity.

7. The incoming mail notification method of an electronic mail server apparatus of claim 6, the method further comprising the processes of:
sending the received electronic mail according to delivery request from the delivery destination apparatus; and
inhibiting delivery of electronic mail to the delivery destination apparatus before the incoming information is sent out.

8. The incoming mail notification method of an electronic mail server apparatus of claim 6, the method further comprising the process of:
deleting electronic mail in a mail archive unit therefrom after sending the mail to the delivery destination apparatus.

9. An incoming mail notification program of an electronic mail server apparatus that sends and receives electronic mail, the program being executed by a computer, the program comprising the steps of:
registering instruction information notified from a delivery destination apparatus of the electronic mail in a registration unit; and
notifying incoming information to the delivery destination apparatus on the basis of the instruction information, with taking mail arrival as an opportunity.

10. The incoming mail notification program of an electronic mail server apparatus of claim 9, the program further comprising the steps of:
sending the received electronic mail according to delivery request from the delivery destination apparatus; and
inhibiting delivery of electronic mail to the delivery destination apparatus before the incoming information is sent out.

11. The incoming mail notification program of an electronic mail server apparatus of claim 9, the program further comprising the step of:
deleting electronic mail in a mail archive unit therefrom after sending the mail to the delivery destination apparatus from which delivery request is sent.
